(19) United States
(12) Patent Application Publication
(10) Pub. No.: US 2023/0294365 A1
(43) Pub. Date: Sep. 21, 2023

(54) METHOD FOR CONNECTING TWO JOINING SURFACES

(71) Applicant: Herrmann Ultraschalltechnik GmbH & Co. KG, Karlsbad (DE)

(72) Inventors: Robin Alexander Bode, Pforzheim (DE); Raquel Roussel-Garcia, Pforzheim (DE); Timo Zink, Karlsruhe (DE)

(21) Appl. No.: 18/021,010

(22) PCT Filed: Aug. 16, 2021
(86) PCT No.: PCT/EP2021/072681

§ 371 Date: Feb. 13, 2023

(30) Foreign Application Priority Data
Aug. 24, 2020 (DE) 10 2020 122 040.5
Dec. 15, 2020 (DE) 10 2020 133 602.0

(51) Int. Cl. B29C 65/08; B29C 65/48; B29C 65/52; B29C 65/78; B29C 65/00

(52) U.S. Cl. CPC B29C 65/086; B29C 65/4815; B29C 65/486; B29C 65/522; B29C 65/7894; B29C 66/0222; B29C 66/1122; B29C 66/45; B29C 66/73921; B29C 66/83411; B29C 66/8762; B29C 66/9513

(57) ABSTRACT

The cutting of fibrous material which does not melt easily is effected to avoid the unravelling of cut edges, using ultrasonic or laser beam techniques. The method includes (a) applying a thermoplastic powder material to the cutting region, and (b) applying thermal shock to the localised area, sufficient to destroy the fibres of the material, and melt the powder on either side of the cut, and (c) pressing the cut edges while the fused thermoplastic powder is still soft. Woven or non-woven fabrics have tendency to unravel, after cutting, and normally require a sewn hem. The method of the invention disposes of the sewn hem, and provides a thermo-cutting technique applicable to non-fusible or non-thermoplastic fibres.

The present invention relates to a method for connecting a first joining surface of a first workpiece to a second joining surface of a second workpiece.

It is already known to join two thermoplastic materials together. To this end, the first joining surface of the first workpiece is brought into contact with the second joining surface of the second workpiece, and then energy is introduced into the first workpiece via a tool part.

The energy input can occur by, e.g., the first tool part introducing a force into the workpiece so that the two joining surfaces are pressed together. Alternatively, heat can also be transferred to the first workpiece via the first tool part so that the joining surface also heats up. Some methods are known as thermobonding and thermocalendering.

Finally, an ultrasonic vibration can also be introduced into the workpiece so that the material of the first workpiece and the material of the second workpiece are melted in the joining zone, i.e., at the joining surfaces. In this context, a joining pressure is usually applied to establish the connection. It is possible to either bring the tool part that is already vibrating with an ultrasonic vibration into contact with the workpiece, or to first bring the tool part into contact with the workpiece and then excite the tool part with an ultrasonic vibration. Ultrasound is understood to mean sound at a frequency of between 1 kHz and 1 GHz. However, ultrasonic frequencies between 15 kHz and 90 kHz are particularly preferable in practice.

However, all of the described methods require that the materials to be joined are able to be melted by the energy input. Therefore, only thermoplastic materials or materials having a thermoplastic moiety can be considered for processing.

If the thermoplastic content in the materials to be welded is too low, an incomplete welding occurs and the joined materials can re-dissolve from one another automatically or with slight force.

However, the market increasingly demands materials with a low thermoplastic content or even materials without a thermoplastic content. In particular, biomaterials from renewable raw materials are in the market trend. Even in the area of hygiene products, increasing demands are placed on the product softness, which can also barely be met with thermoplastic materials.

Such materials, according to current knowledge, cannot be joined or can only be joined with great effort by energy input alone, so that adhesive is often used instead, which leads to higher costs for the product or packaging and is disadvantageous from an environmental standpoint.

Based on the prior art described, it is therefore the object of the present invention to specify a method that can also weld materials having a low thermoplastic content, or even materials without a thermoplastic content, without the need for adhesives.

According to the invention, this object is achieved in that particles formed from thermoplastic material are applied to the first and/or second joining surface before the two joining surfaces of the two workpieces are brought into contact with each other.

The particles made of thermoplastic material are simply applied to the first or the second joining surface superficially and thereby lead to an increase in the thermoplastic content at the surface. Surprisingly, even small amounts of thermoplastic particles have been shown to significantly improve the bonding properties between the two workpieces. It is therefore only necessary to increase the thermoplastic content at the surface, in particular on one of the joining surfaces. In contrast, no thermoplastic material need be provided in the workpieces.

The teaching according to the invention can be used in all methods that create a connection by means of energy input. Preferably, the teaching according to the invention is applied to ultrasonic welding. Therefore, the invention will be described below with reference to the ultrasonic welding method. In principle, however, the invention can also be used in other methods, e.g., thermal bonding or thermal calendaring.

In ultrasonic welding, the two workpieces are typically positioned between a sonotrode acting as the first tool part and an anvil acting as the second tool part so that, during the welding process, either the sonotrode or the anvil exerts a joining force on the materials and presses the two joining surfaces together.

It is also possible that a sonotrode is also used as the second tool part that faces the first tool part, which is also placed in a state of ultrasonic vibration.

Using the measure according to the invention, materials having a low thermoplastic content can be joined together. It is even possible to join one or two workpieces made of a material that has no thermoplastic content whatsoever.

The bond strength can be increased by at least one workpiece, preferably both workpieces, consisting of a fibrous material, e.g., a fabric or a nonwoven material, a fibre-impregnated material, or a porous material.

The thermoplastic particles can have a size smaller than the average pore size or smaller than the average distance between adjacent fibres. Upon application of the thermoplastic particles, they can then go into the pores or between the fibres. For example, the particles can have a maximum extent of between 100 and 300 μm.

The thermoplastic particles can then penetrate into pores or interstitial fibre spaces after they are melted, thereby significantly increasing the strength of the connection. The melted thermoplastic particles then clasp to the pores or interstices of the fibres and hold the joining surfaces together. The proportion of thermoplastic particles can be very low, since they are only used to join the joining surfaces. In one preferred embodiment, the particles are scattered onto the surface.

In a further preferred embodiment it is provided that, before the two joining surfaces are brought into contact with each other, depressions are introduced into one or both joining surfaces, preferably before the thermoplastic particles are applied to one or both of the joining surfaces. For example, one of the joining surfaces can be brought into contact with a punch having needle-shaped protrusions. If a workpiece is strip-shaped, the strip-shaped workpiece can be unrolled via a roller having corresponding needle-shaped protrusions. It is also possible to design the depressions to have undercuts in order to increase the connection strength between the two joining surfaces.

By introducing depressions, the strength of the compound is significantly increased so that materials that do not have pores or fibres can also be well connected.

In a further preferred embodiment, thermoplastic particles not melted together with the first or second joining surface are removed after ultrasonic processing. This can be performed by means of suction, for example.

In a preferred embodiment, fibre-shaped or platelet-shaped thermoplastic particles are used because they cannot slip or roll down as easily from the joining surfaces. The thermoplastic particles can simply be scattered onto the joining surface.

The invention is particularly advantageous if the first workpiece, and preferably also the second workpiece, are strip-shaped, so that the two workpieces can then even be moved through the gap remaining between the first tool part, i.e. the sonotrode, by way of example, and the second tool part, i.e. the anvil, by way of example, during machining. A continuous connection between the two strips can take place as a result.

The invention is not limited to connecting exactly two workpieces. It is also possible to connect more than two workpieces. For example, if three strips of material are welded together, thermoplastic particles should be introduced between both the first and second strips of material and between the second and third strips of material if all three strips of material have too little thermoplastic content.

Further advantages, characteristics, and possible applications of the present invention will become apparent from the following description of a preferred embodiment and the corresponding drawings.

Shown is:

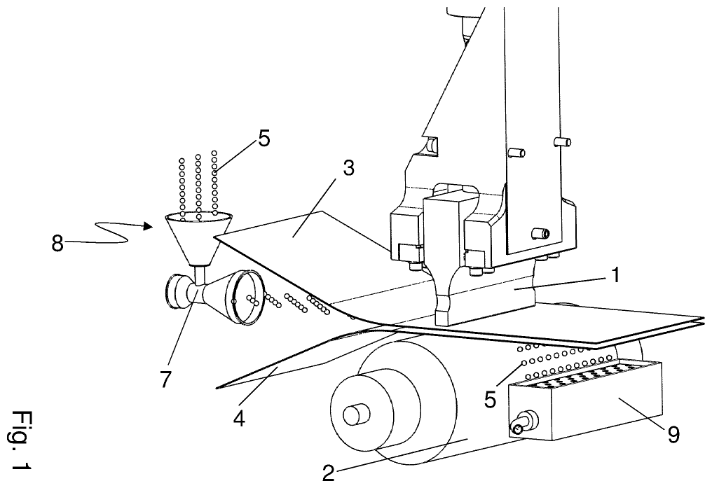

FIG. 1 is a schematic view of a first embodiment according to the invention.

FIG. 1 shows a first embodiment that implements the method according to the invention.

A sonotrode 1 and an counter-tool 2 are provided. The counter tool 2 is cylindrical in this case. The sonotrode 1 can be set into ultrasonic vibration. Two strips of material 3, 4 are intended to be welded together. Thus, they are guided on top of each other through the gap between the sonotrode 1 and the counter-tool 2. The feed rate of the strips of material corresponds to the circumferential speed of the anvil roll 2.

While the two strips of material 3, 4 are passing between the sonotrode 1 on the one hand and the counter-tool 2 on the other hand, a joining force is applied to the strips and an ultrasonic vibration is generated. To improve the adhesion between the strips of material, thermoplastic particles 5 are applied via the feeder 8 to a joining surface of the strip of material 4. The feed may be performed using an auger (not shown) and an air-to-air venturi nozzle 7.

The added thermoplastic particles 5 can rest loosely and on the strip of material 4 before the latter comes into contact with the strip of material 3. By means of the method according to the invention, the two strips of material 3, 4 are then present between the sonotrode 1 and the anvil 2, and individual thermoplastic particles 5 are present between the strips of material.

During ultrasonic processing, the thermoplastic particles 5 are melted so that they can penetrate into corresponding pores, fibre gaps, or previously introduced depressions in the strip of material 3, or in the strip of material 4. Once both strips of material have then completed processing by the sonotrode 1, a suction device 9 is provided that suctions excess thermoplastic particles 5.

Using the method according to the invention, natural fibres, e.g. cotton, can be connected to one another. For example, materials made of PP/PET fibres can already be effectively connected to one another.

### LIST OF REFERENCE SIGNS

1 Sonotrode
2 Counter-tool
3, 4 Strip of material
5 Thermoplastic particles 7 Venturi nozzle
8 Feed
9 Suction device

1. A method for connecting a first joining surface of a first workpiece (3) to a second joining surface of a second workpiece (4), said method having the steps of:
1) bringing the first and the second joining surfaces into contact with each other,
2) bringing a first tool part (1) into contact with the first workpiece (3) and introducing energy into the first workpiece (3) via the first tool part (1),
characterised in that
before step 1) a step of:
A) applying particles (5) formed from thermoplastic material to the first and/or second joining surface is performed and, during step 2), the particles (5) formed from thermoplastic material are melted and the first and second joining surfaces are connected to one another.

2. The method according to claim 1, characterized in that, at the same time as step 2), the step of:
3) bringing a second tool part (2) into contact with the second workpiece (4) is performed.

3. The method according to claim 1, characterized in that at least one workpiece (3, 4) does not consist of a thermoplastic material.

4. The method according to claim 1, characterized in that at least one workpiece (3, 4), consists of a fibrous material or a porous material.

5. The method according to claim 1, characterized in that, before step 1):
B) introduction of depression into the first and/or second joining surface is performed.

6. The method according to claim 1, characterized in that, after step 2):
3) removal of thermoplastic particles (5) not melted together with the first or second joining surfaces
is performed.

7. The method according to claim 1, characterized in that the thermoplastic particles (5) are sphere-shaped, fibre-shaped, or platelet-shaped.

8. The method according to claim 1, characterized in that both the first workpiece (3) and the second workpiece (4) are strip-shaped.

9. The method according to claim 1, characterized in that, during step 2), energy is introduced into the first workpiece (1) by vibrating the first tool part (3) with an ultrasonic vibration.

10. The method according to claim 11 characterized in that, during step 3), the second tool part (2) is vibrated with an ultrasonic vibration.

11. The method according to claim 2, characterized in that, during step 2), energy is introduced into the first workpiece (1) by vibrating the first tool part (3) with an ultrasonic vibration.

12. The method according to claim 3 wherein both workpieces do not consist of a thermoplastic material.

13. The method according to claim 4, characterized in that both workpieces, consist of a fibrous material or a porous material.

14. The method according to claim 5, wherein step B) is performed before step A).

15. The method according to claim 6 wherein step 3) is performed by means of suction.

16. The method according to claim 8 wherein the two workpieces (3, 4) are moved during step 2).
